(19) United States
(12) Patent Application Publication
(10) Pub. No.: US 2024/0308762 A1
(43) Pub. Date: Sep. 19, 2024

(54) GRIPPER ASSEMBLY

(71) Applicant: Ocado Innovation Limited, Hatfield, Hertfordshire (GB)

(72) Inventors: Wilhelm Karl JOHANNISSON, Hatfield, Hertfordshire (GB); Alice MOSS, Hatfield, Hertfordshire (GB); Xuan SUN, Hatfield, Hertfordshire (GB); Malte GRUBER, Hatfield, Hertfordshire (GB); Mans FALLMAN, Hatfield, Hertfordshire (GB)

(73) Assignee: Ocado Innovation Limited, Hatfield, Hertfordshire (GB)

(21) Appl. No.: 18/575,171

(22) PCT Filed: Jun. 28, 2022
(86) PCT No.: PCT/EP2022/067757

§ 371 Date: Dec. 28, 2023

(30) Foreign Application Priority Data
Jun. 29, 2021 (GB) 2109317.4

(51) Int. Cl. B65G 1/04; B25J 15/00; B65G 47/90

(52) U.S. Cl. CPC B65G 1/0464; B25J 15/0023; B25J 15/0047; B65G 47/90

(57) ABSTRACT

The disclosure relates to a gripper assembly and in particular a gripper assembly for a load-handling device used to carry storage containers. In one embodiment, the gripper assembly includes a pair of gripper arms moveable between an open configuration, in which the gripper arms can engage with a storage container, and a closed configuration, in which the gripper arms are prevented from engaging the storage container. The gripper assembly includes an actuator having a plunger and two pins connected to the plunger, each pin is received within a respective track formed within each gripper arm. The plunger is configured to move in an opening stroke to move the pair of gripper arms into the open configuration and a closing stroke to move the pair of gripper arms into the closed configuration.

The invention relates to a gripper assembly and in particular a gripper assembly for a load-handling device.

### BACKGROUND

Robotic load-handling devices are described in UK Patent Application No. GB2520104A (Ocado Innovation Limited). Such load-handling devices are controllably moved on a track system forming a grid above stacks of bins or containers. A given load-handling device lifts a target container from the top of a stack, the target container containing inventory items needed to fulfil a customer order. The target container is carried to a pick station where the required inventory item may be manually removed from therefrom and placed in a delivery container, the delivery container forming part of the customer order, and being manually filled for dispatch at the appropriate time. At the pick station, the items may also be picked by industrial robots, suitable for such work, for example as described in UK Patent Application No GB2524383B (Ocado Innovation Limited). The load-handling devices each comprise a container-engaging assembly for engaging the target container and a container-lifting means for lowering and raising the container-engaging assembly. The container-engaging assembly comprises a gripper assembly connecting the container-engaging assembly to the target container. It is essential that the gripper assembly is robust, reliable and able to support the weight of the target container, so that it is able to withstand repeated use.

It is against this background that the invention was devised.

### SUMMARY

Accordingly, there is provided, in a first aspect, a load-handling device for lifting and moving storage containers stacked in a grid framework structure comprising a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising a body mounted on a first set of wheels being arranged to engage with the first set of parallel rails or tracks and a second set of wheels being arranged to engage with the second set of parallel rails or tracks; and, a gripper assembly for latching onto a storage container, the gripper assembly comprising a pair of gripper arms moveable between an open configuration, in which the pair of gripper arms can engage with a storage container, and a closed configuration, in which the pair of gripper arms are prevented from engaging a storage container, wherein each gripper arm of the pair of gripper arms comprises a track; an actuator comprising a plunger and two pins connected to the plunger, each pin being moveably received within a respective track of the pair of gripper arms, wherein the plunger is configured to move in an opening stroke to move the pair of gripper arms into the open configuration and a closing stroke to move the pair of gripper arms into the closed configuration, and wherein the tracks are arranged to diverge with respect to each other in the direction of the closing stroke when the pair of gripper arms are in the closed configuration.

Optionally, each gripper arm of the pair of gripper arms is movable about a respective rotational axis.

Optionally, the tracks are located between the rotational axis and an end of their respective gripper arm connected to the plunger.

Alternatively, the tracks are located between the rotational axis and an end of their respective gripper arm configured to engage a storage container.

Optionally, the tracks are offset from and extend either side of the rotational axis of their respective gripper arm.

Optionally, the track of each gripper arm comprises a slot, and wherein the two pins extend through their respective slot and are connected to the plunger at each of their ends.

Optionally, the gripper assembly further comprises a brace connecting the plunger and pins.

Optionally, the brace substantially prevents relative spatial movement between the pins.

Optionally, the brace and pins are configured to allow each pin to rotate about its longitudinal axis.

Optionally, the gripper assembly further comprises a housing configured to limit movement of the gripper assembly with respect to a storage container.

Optionally, the pins and tracks are located within the housing.

Optionally, the gripper assembly further comprises a biasing means for biasing the gripper arms in the open configuration.

Optionally, the rotational axis of each gripper arm is positioned towards an outer side of the gripper arm.

In a second aspect, there is provided a load-handling device for lifting and moving storage containers stacked in a grid framework structure comprising a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising a body mounted on a first set of wheels being arranged to engage with the first set of parallel rails or tracks and a second set of wheels being arranged to engage with the second set of parallel rails or tracks; and, a gripper assembly for latching onto a storage container, the gripper assembly comprising: a body section; a single gripper arm configured to move between a stowed position, in which the arm is received within the body section, and a deployed position for engaging with a storage container; and, an actuator comprising a pin connected to the arm, wherein the pin is configured to move between first and second positions to move the arm between the stowed and deployed positions respectively.

Optionally, the pin is configured to rotate about its longitudinal axis to move between the first and second positions.

Optionally, the body section comprises a collar configured to limit movement of the gripper assembly with respect to a storage container.

Optionally, an end of the body section remote from the actuator is tapered.

Optionally, the gripper assembly further comprises a biasing means for biasing the arm in the deployed position.

Optionally, the pin extends into the body section either side of the gripper arm.

Optionally, the gripper arm comprises convex surfaces, each having an apex configured to slidably engage with the body section.

A load-handling device for lifting and moving storage containers stacked in a grid framework structure comprising a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising a body mounted on a first set of wheels being arranged to engage with the first set of parallel rails or tracks and a second set of wheels being arranged to engage with the second set of parallel rails or tracks; and, a gripper assembly for latching onto a storage container, the gripper assembly comprising a pair of gripper arms moveable between a stowed configuration and a deployed configuration for engaging with a storage container; biasing means providing a force to bias the pair of gripper arms in the deployed configuration; and, an actuator comprising two wires, each cable being connected to a respective gripper arm of the pair of gripper arms, wherein the actuator is configured to pull the two wires to move the pair of gripper arms to the stowed configuration and enable the gripper arms to return to the deployed configuration under the force of the biasing means.

Optionally, the actuator is configured to wind the two wires in order to move the pair of gripper arms and unwind the two wires to enable the gripper arms to return to the deployed configuration under the force of the biasing means.

Optionally, the gripper assembly further comprises a body section, and wherein the two wires extend through the body section.

Optionally, an end of the body section remote from the actuator is tapered.

In all of the above aspects, the actuator can be a solenoid or another type of linear actuator, or a servo motor.

### BRIEF DESCRIPTION OF THE DRAWINGS

These and other aspects of the invention will now be described, by way of example only, and with reference to the accompanying drawings, in which:

FIG. 1 schematically illustrates a storage structure and containers;

FIG. 2 schematically illustrates track on top of the storage structure illustrated in FIG. 1;

FIG. 3 schematically illustrates load-handling devices on top of the storage structure illustrated in FIG. 1;

FIG. 4 schematically illustrates a single load-handling device with a container-lifting means and a container-engaging assembly in a lowered configuration;

FIG. 5 schematically illustrates cutaway views of a single load-handling device with the container-lifting means of FIG. 4 in a raised and a lowered configuration;

FIGS. 6a and 6b show a first embodiment of a gripper assembly for use with the container-engaging assembly of FIG. 4;

FIGS. 7a to 7d show a second embodiment of a gripper assembly for use with the container-engaging assembly of FIG. 4;

FIG. 8 is a perspective illustration of a brace of the gripper assembly of FIGS. 7a to 7d;

FIGS. 9a and 9b show a third embodiment of a gripper assembly for use with the container-engaging assembly of FIG. 4;

FIGS. 10a to 10c show a fourth embodiment of a gripper assembly for use with the container-engaging assembly of FIG. 4;

FIGS. 11a and 11b show a fifth embodiment of a gripper assembly for use with the container-engaging assembly of FIG. 4;

FIGS. 12a and 12b show a sixth embodiment of a gripper assembly for use with the container-engaging assembly of FIG. 4;

FIGS. 13a to 13c show a seventh embodiment of a gripper assembly for use with the container-engaging assembly of FIG. 4;

FIGS. 14a to 14c show an eighth embodiment of a gripper assembly for use with the container-engaging assembly of FIG. 4;

FIGS. 15a to 15c show a ninth embodiment of a gripper assembly for use with the container-engaging assembly of FIG. 4;

FIGS. 16a and 16b show a tenth embodiment of a gripper assembly for use with the container-engaging assembly of FIG. 4; and,

FIGS. 17a to 17e show an eleventh embodiment of a gripper assembly for use with the container-engaging assembly of FIG. 4.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

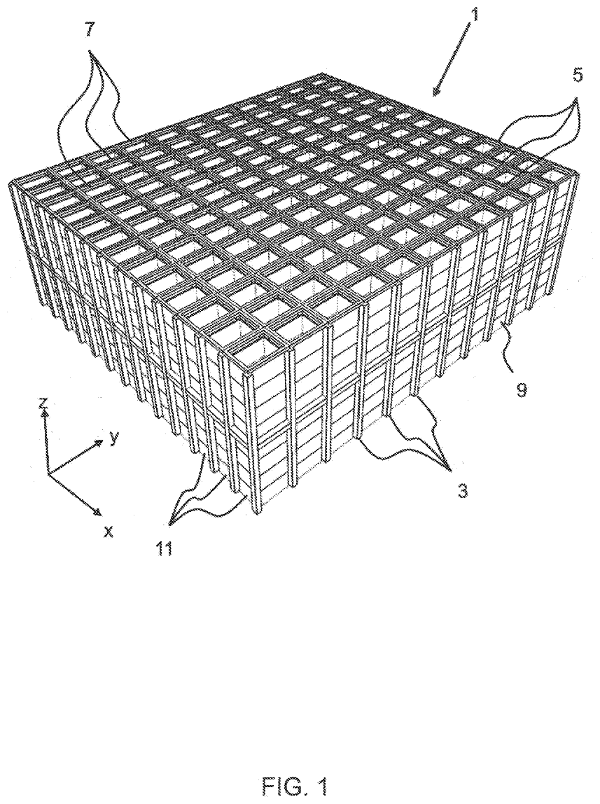

FIG. 1 illustrates a storage structure 1 comprising upright members 3 and horizontal members 5, 7 which are supported by the upright members 3. The horizontal members 7 extend parallel to one another and the illustrated x-axis, whereas the horizontal members 5 extend parallel to one another and the illustrated y-axis, transversely to the horizontal members 7. The upright members 3 extend parallel to one another and the illustrated z-axis. The horizontal members 5, 7 form a grid pattern defining a plurality of grid cells. In the illustrated example, containers 9 are arranged in stacks 11 beneath the grid cells defined by the grid pattern, with one stack 11 of containers 9 per grid cell.

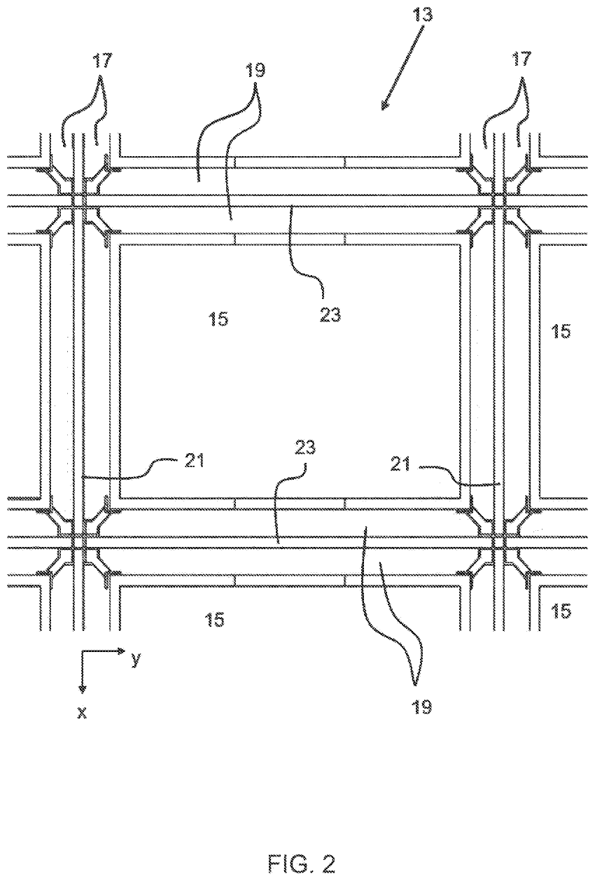

FIG. 2 shows a large-scale plan view of a section of a track structure, generally designated by 13, located on top of the horizontal members 5, 7 and forming part of the storage structure 1 illustrated in FIG. 1. The track structure 13 may be provided by the horizontal members 5, 7 themselves (e.g., formed in or on the surfaces of the horizontal members 5, 7) or by one or more additional components mounted on top of the horizontal members 5, 7. The illustrated track structure 13 comprises x-direction tracks 17 and y-direction tracks 19. In this case, a first set of tracks 17 extend in the x-direction and a second set of tracks 19 extend in the y-direction, transverse to the first set of tracks 17. The tracks 17, 19 define apertures 15 at the centres of the grid cells. The apertures 15 are sized to allow containers 9 located beneath the grid cells to be lifted and lowered through the apertures 15. The first set of tracks 17 are provided in pairs separated by ridges 21, and the second set of tracks 19 are provided in pairs separated by ridges 23. Other arrangements of the track structure 13 may also be possible.

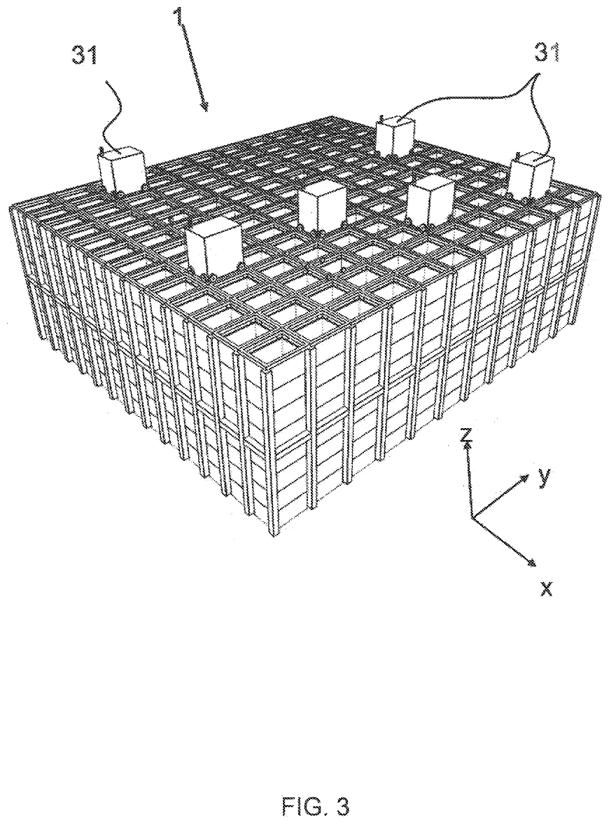

FIG. 3 shows a plurality of robotic load-handling devices 31 moving on top of the storage structure 1 illustrated in FIG. 1. Each load-handling device 31, which may also be referred to as a robot 31 or bot 31, is provided with a direction-change assembly (not shown) and sets of wheels to engage with corresponding x- or y-direction tracks 17, 19 to enable the bot 31 to travel across the track structure 13 and reach specific grid cells. As mentioned, the sets of tracks 17, 19 are separated by ridges 21, 23 allowing a pair of bots 31 to occupy neighbouring grid cells or pass one another without colliding.

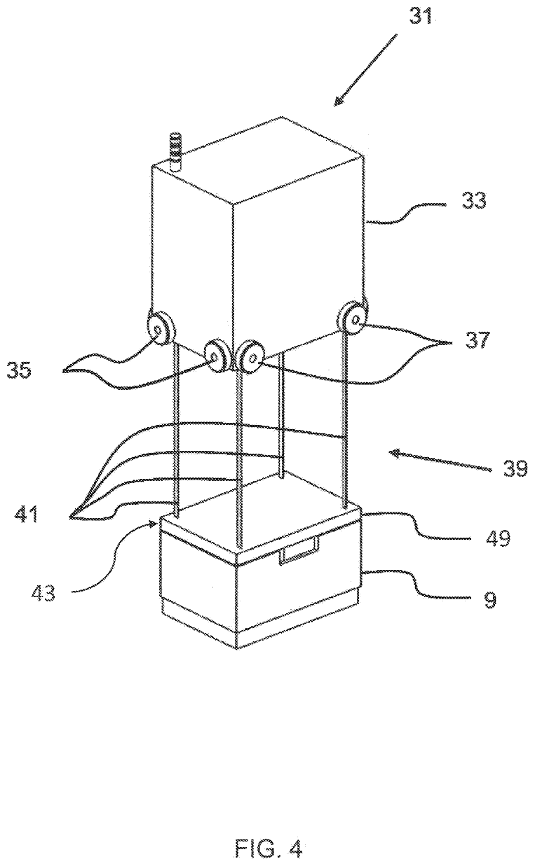

As illustrated in detail in FIG. 4, a bot 31 comprises a body 33 in or on which are mounted one or more components which enable the bot 31 to perform its intended functions. These functions may include moving across the storage structure 1 on the track structure 13, and lowering or raising containers 9 to or from the stacks 11 so that the bot 31 can deposit or retrieve containers 9 in specific locations defined by the grid pattern.

In order to perform the former function, the bot 31 comprises first and second sets of wheels 35, 37, which are mounted on the body 33 and enable the bot 31 to move in the x- and y-directions along the tracks 17 and 19, respectively. In particular, two wheels 35 are provided on the shorter side 36 of the bot 31 visible in FIG. 4, and a further two wheels 35 are provided on the opposite shorter side 36 of the bot 31. The wheels 35 are rotatably mounted on the body 33 and are configured to engage with tracks 17 to allow the bot 31 to move along the tracks 17. Analogously, two wheels 37 are provided on the longer side 38 of the bot 31 visible in FIG. 4, and a further two wheels 37 are provided on the opposite longer side 38 of the bot 31. The wheels 37 engage with tracks 19 and are rotatably mounted on the body 33 of the bot 31 to allow the bot 31 to move along the tracks 19.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

In furtherance of the latter function, the bot 31 further comprises container-lifting means, generally designated by 39, configured to raise a container 9 from a stack 11 into a container-receiving space or cavity of the bot 31, and lower a container 9 from the container-receiving space onto a stack 11. The illustrated container-lifting means 39 comprises four tapes or reels 41 which are connected at their lower ends to a container-engaging assembly 43. The tapes 41 may be wound up or down to raise or lower the container-engaging assembly 43, as required. One or more motors or other means may be provided to effect or control the winding up or down of the tapes 41.

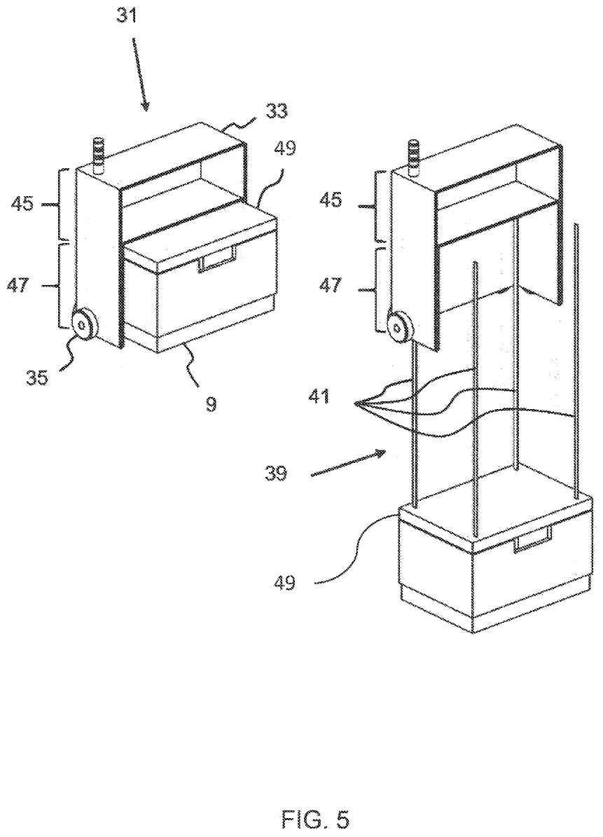

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45 and comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-engaging assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31 (e.g., in a cantilever arrangement with the weight of the body 33 of the bot 31 counterbalancing the weight of the container to be lifted). In such embodiments, a frame or arms of the container-lifting means 39 may protrude horizontally from the body 33 of the bot 31, and the tapes/reels 41 may be arranged at respective locations on the protruding frame and configured to be raised and lowered from those locations to raise and lower a container into the container-receiving space adjacent to the body 33. The height at which the frame is mounted on and protrudes from the body 33 of the bot 31 may be chosen to provide a desired effect. For example, it may be preferable for the frame to protrude at a high level on the body 33 of the bot 31 to allow a comparatively larger container or a plurality of containers to be raised into the container-receiving space beneath the frame. Alternatively, the frame may be arranged to protrude lower down the body 33 (but still high enough to accommodate at least one container between the frame and the track structure 13) to keep the centre of mass of the bot 31 lower when the bot 31 is loaded with a container.

In the embodiment shown, the container-engaging assembly 43 comprises a gripper plate 49 attached to the lower ends of the tapes 41 and one or more gripper assemblies (not shown) mounted thereon for latching to a container 9. The gripper assemblies, which may, for example, be provided at the corners of the gripper plate 49, in the vicinity of the tapes 41, are arranged to align with recesses or opening in the containers 9 and interact therewith when activated in order to latch to the containers 9.

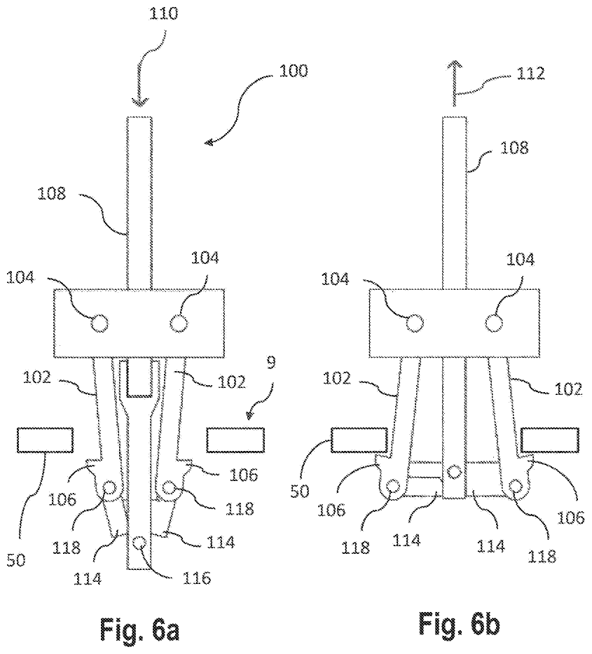

FIGS. 6a and 6b show a first embodiment of a gripper assembly, generally designated by 100, for use on the load-handling devices 31 described herein. The gripper assembly 100 comprises a pair of gripper arms 102 rotatable, about respective pins 104 each defining a rotational axis, between a closed configuration, as shown in FIG. 6a, and an open configuration, as shown in FIG. 6b. When in the closed configuration, the gripper arms 102 are held in a folded position, enabling them to pass through a recess or opening in a container rim 50 as the gripper plate 49 is lowered. Once the gripper assembly 100 has been lowered sufficiently, the gripper arms 102 are moved to the open configuration in which they are held in an extended position. Each arm 102 comprises a lateral protrusion 106 configured to engage the underside of the container rim 50 when the gripper arms 102 are in the extended position and the gripper assembly 100 is lifted. It is through this engagement, between the lateral protrusions 106 and the container rim 50, that the gripper assembly 100 latches onto the container 9 in order to raise it from a stack 11.

The gripper assembly 100 further comprises an actuator for moving the gripper arms 102 between the folded and extended positions. The actuator comprises a plunger 108 configured to move substantially linearly in a downwards closing stroke, as indicated by arrow 110, to move the gripper arms 102 to the folded position, and an upwards opening stroke, as indicated by arrow 112, to move the gripper arms 102 to the extended position. The gripper assembly 100 further comprises two arm linkages 114 that convert the linear motion of the plunger 108 into the rotary motion of the gripper arms 102, moving them between the folded and extended positions. To that end, each arm linkage 114 is rotatably connected at one of its ends to the lower end of the plunger 108 by pin 116 and at its other end to a respective gripper arm 102 by pins 118. During the closing stroke 110 of the plunger 108, the pin 116 connecting the plunger 108 and arm linkages 114 is lowered with respect to the pins 118 connecting the gripper arms 102 and arm linkages 114. This relative movement causes the arm linkages 114 to rotate inwards towards the plunger 108 about pin 116. This action, in turn, causes the gripper arms 102 also to rotate about their respective pins 104 into the folded position. During the opening stroke 112 of plunger 108, the pin 116 connecting the plunger 108 and arm linkages 114 is raised with respect to the pins 118 connecting the gripper arms 102 and arm linkages 114. This causes the arm linkages 114 to rotate about the pin 116 away from the plunger 108 into substantially horizontal positions, pushing the gripper arms 102 outwards into the extended position. When lifting a container 9, the weight of the container 9 acts on the lateral protrusions 106 to apply a torque to the gripper arms 102 urging them towards the plunger 108 to lock the gripper assembly 100 in the open configuration.

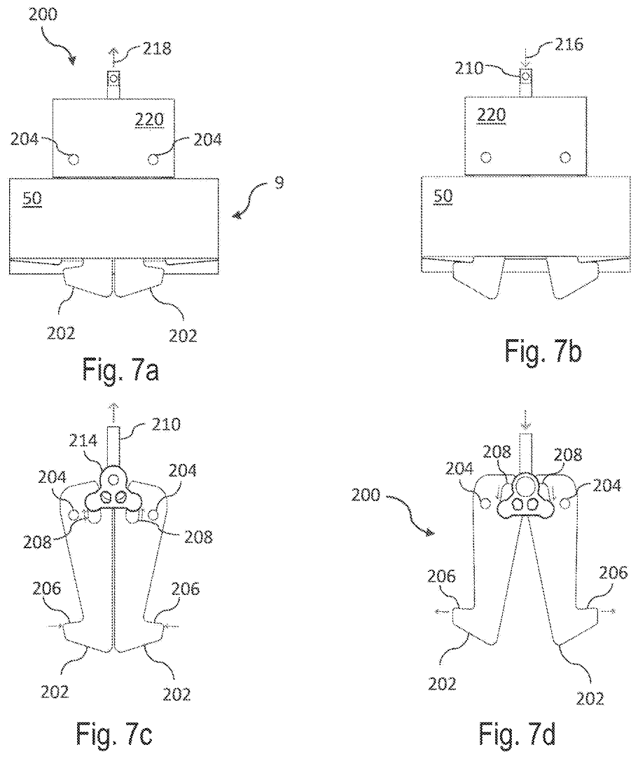

FIGS. 7a to 7d show a second embodiment of a gripper assembly 200 for use on the load-handling devices 31 described herein. FIGS. 7a and 7b show the gripper assembly 200 received within a recess or opening in a container rim 50, and FIGS. 7c and 7d show only the gripper assembly 200. The gripper assembly 200 comprises a pair of gripper arms 202 moveable, about respective pins 204 each defining a rotational axis, between an open configuration, as shown in the FIGS. 7b and 7d, and a closed configuration, as shown in FIGS. 7a and 7c. The gripper arms 202 each comprise a hooked end 206, defining an upper surface with which to engage an underside of the container rim 50 during the lifting of the container 9. The gripper assembly 200 further comprises an actuator, such as a solenoid, having a plunger 210 and two pins 212 connected to the plunger 210 by a brace 214. The two pins 212 are slidably received within a respective track 208 of the gripper arms 202 for transferring movement of the plunger 210 to the gripper arms 202. The plunger 210 is configured to move in an opening stroke to move the pair of gripper arms 202 to the open configuration and a closing stroke to move the pair of gripper arms 202 to the closed configuration. In this embodiment, the opening stroke consists of a substantially vertical downwards stroke, as indicated by 216, and the closing stroke consists of a substantially vertical upwards stroke, as indicated by 218. In other embodiments, the opening stroke may be a upward stroke and the closing stroke may be a downward stroke, but regardless of the direction of the strokes 216, 218, the tracks 208 are arranged to diverge with respect to each other in the direction of the closing stroke 218 when the pair of gripper arms 202 are in the closed configuration. It is this divergent arrangement of the tracks 208 that causes the gripper arms 202 to move between the open and closed configurations during the opening and closing strokes 216, 218 of the plunger 210.

The gripper assembly 200 further comprises a biasing means configured to provide a force to bias the gripper arms in the open configuration so as to maintain this configuration in the event of a failure to the actuator. To that end, the rotational axes defined by pins 204 are positioned towards an outer edge of their respective gripper arms 202, imparting on the gripper arms 202 a natural tendency to hang in the open configuration in the absence of an external force. In addition to this or instead of, a biasing element, such as a coil spring (not shown), could be used in the actuator to bias the gripper arms 202 in the open configuration.

In this embodiment, the track 208 of each gripper arm 202 is horizontally offset from its respective rotational axis defined by pins 204, and extends either side of the rotational axis in a generally vertical direction when the pair of gripper arms 202 are in the closed configuration. However, the tracks 208 may be configured alternatively and located anywhere on the gripper arms 202. For example, the tracks 208 are located between the rotational axis 204 and the end of the gripper arm 202 configured to engage a container 9. In yet further embodiments, the tracks 208 are located between the rotational axis and the end of their respective gripper arm 202 connected to the plunger 210. Locating the tracks 208 relatively high on the gripper arms 202, similar to the embodiment of the gripper assembly 200 shown in FIGS. 7a to 7d, means that the tracks 208, together with the pins 212, brace 214 and any other components needed for connecting the actuator to the gripper arms 202, need not pass through the recess of a container 9 in order for the gripper arms 202 to engage the container 9. So the size of the recess only has to be large enough to allow passage of the lower parts of the gripper arms 202. This not only minimises any modifications to containers 9 and but also means that the physical specifications of the components that are not required to pass through the recess are independent of the size of the recess, allowing a greater scope for their alteration, for example, should they need to be made larger for supporting greater loads. The gripper assembly 200 further comprises a housing 220 (not shown in FIGS. 7c and 7d) enclosing the tracks 208, pins 212, brace 214 and any other components providing a connection between the gripper arms 202 and actuator. This housing 220 serves to protect these components from external damage and is configured, in use, to abut the upper surface of the container rim 50, limiting the downward movement of the gripper assembly 200 with respect to the container 9.

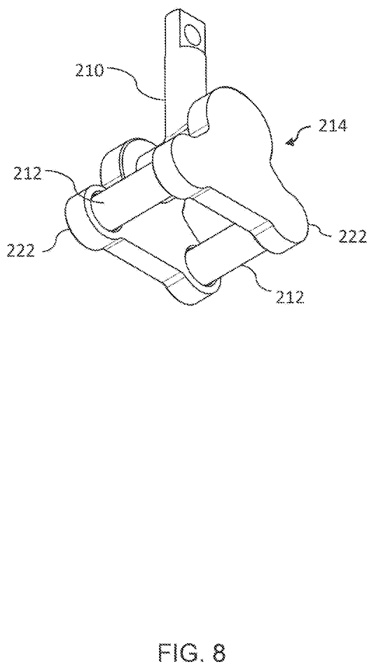

FIG. 8 shows the brace 214 in more detail, connecting a lower end of the plunger 210 to the pair of pins 212. In this embodiment, the tracks 208 of the gripper arms 202 comprises elongate slots through which the pins 212 extend, and the brace 214 comprises two opposed clamping members 222, arranged to be positioned either side of the slots, for establishing a secure connection between each end of the pins 212 and the plunger 210. This secure connection prevents relative spatial movement between the pins 212 during the opening and closing strokes as the pins 212 travel along the divergent slots.

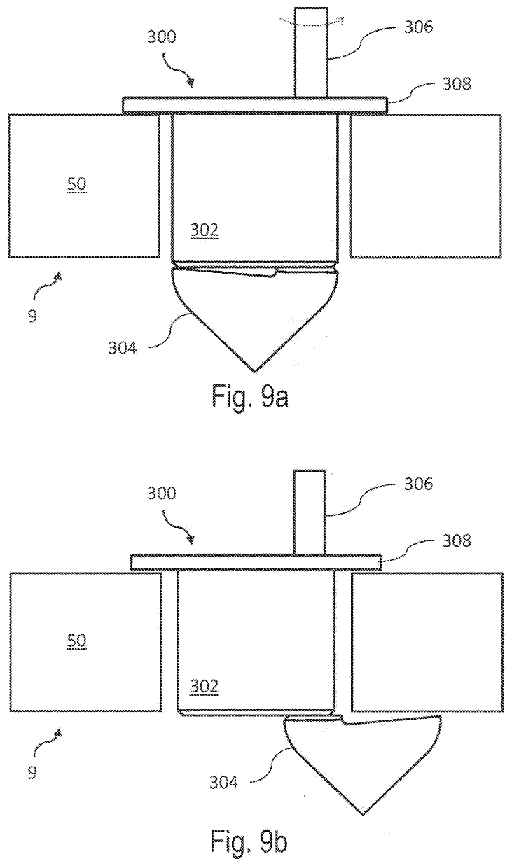

FIGS. 9a and 9b show a third embodiment of a gripper assembly 300 comprising a body section 302 and a moveable end section 304 for engaging with containers 9. The gripper assembly 300 further comprises an actuator comprising a rotatable pin 306 that extends through the body section 302 and connects to the end section 304, which is tapered in order to assist with guiding the gripper assembly 300 through a recess or opening in the container rim 50 of a container 9. The rotatable pin 306 is configured to move the end section 304 between a stowed position where it is held below the body section 302, as shown in FIG. 9a, and a deployed position where it is rotated away from the body section 302 for engaging with a container 9, as shown in FIG. 9b. The gripper assembly 300 further comprises a collar 308 configured to abut the rim 50 of the container 9, limiting the downwards movement of the gripper assembly 300, as the gripper assembly 300 passes through the opening in the container rim 50 when the end section 304 is in the stowed position. From here, the end section 304 is rotated into the deployed position in order to engage the underside of the container rim 50 in order to lift the container 9 as the container-lifting means 39 raises the container-engaging assembly 43. Unlike the two previous embodiments of the gripper assemblies 100, 200, this embodiment 300 has a single contact point for containers 9, provided on the end section 304. The end section 304 is held at the end of the rotatable pin 306 and is not directly supported by the body section 302, meaning that the forces acting on the gripper assembly 300 from carrying a container 9 are distributed across the container-engaging assembly 43 predominantly through the rotatable pin 306.

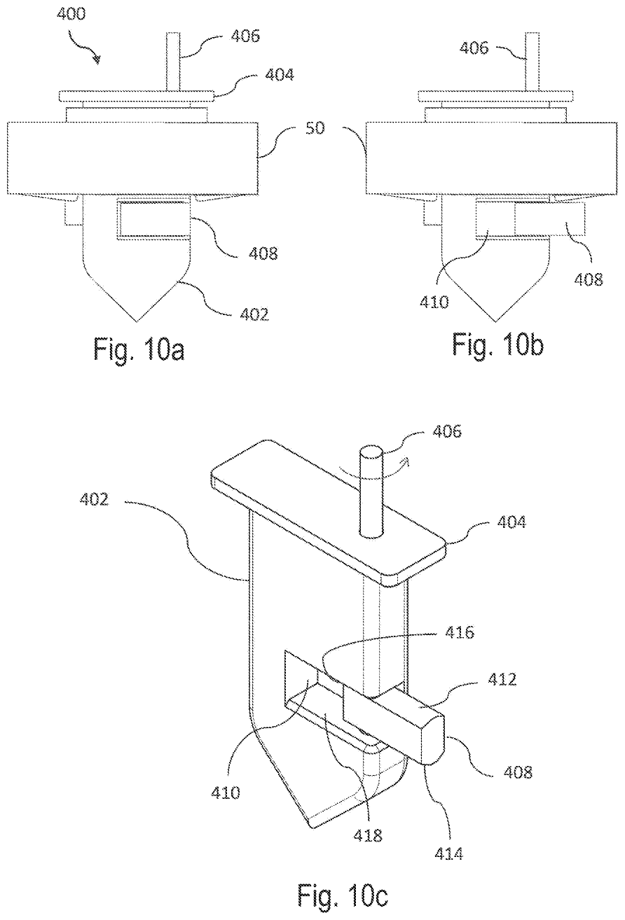

FIGS. 10a to 10c show a similar gripper assembly 400 when compared to the previous embodiment 300 but with an improved load distribution. Like the previous embodiment 300, this embodiment of the gripper assembly 400 comprises a body section 402 having a collar 404 configured to abut the rim 50 of a container 9 for limiting the downwards movement of the gripper assembly 400, although the reader will understand that the collar 404 is not central to the operation of the gripper assembly 400. The lower end of the body section 402 is tapered in order to assist with guiding the gripper assembly 400 through a recess or opening in the container rim 50 as the container-lifting means 39 lowers the container-engaging assembly 43. The gripper assembly 400 also comprises an actuator comprising rotatable pin 406 that extends through the body section 402 and connects to a single gripper arm 408. The rotatable pin 406 extends into the body section 402 on either side of the gripper arm 408 (i.e., above and below the gripper arm 408), such that its lower end is contained within the body section 402, and is configured to rotate about its longitudinal axis to move the gripper arm 408 between a stowed position, where it is held within a cavity 410 in the body section 402, as shown in FIG. 10a, and a deployed position where it is rotated away or out from the body section 402 for engaging with the container 9, as shown in FIGS. 10b and 10c. The upper and lower surfaces 412, 414 of the gripper arm 408 are convex surfaces, each having an apex configured to slidably engage with respective upper and lower surfaces 416, 418 of the cavity 410. And parts of the upper and lower surfaces 412, 414 of the gripper arm 408, those in proximity of the rotatable pin 406, remain in contact with the upper and lower surfaces 416, 418 of the cavity 410 when the gripper arm 408 is in the deployed position. In this arrangement, the gripper arm 408 is supported by the body section 402 and, to a lesser extent, the rotatable pin 406, so the forces acting on the gripper assembly 400 from carrying a container 9 are for the most part distributed through the body section 402, providing a better load distribution when compared to the previous embodiment 300. The gripper assembly 400 further comprises a biasing means (not shown) configured to provide a force to bias the gripper arm 408 in the deployed position so as to maintain this configuration in the event of a failure to the actuator.

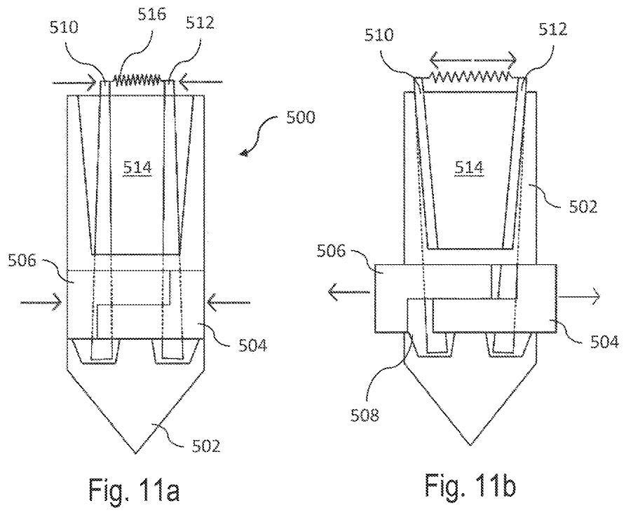

FIGS. 11a and 11b show a fifth embodiment of a gripper assembly 500 comprising a body section 502 carrying two horizontal gripper arms 504, 506 moveable between a stowed position in which the gripper arms 504, 506 are held within a cavity 508 of the body section 502, as shown in FIG. 11a, and a deployed position in which the gripper arms 504, 506 outwardly extend from the body section 502, as shown in FIG. 11b. The gripper assembly 500 further comprises an actuator comprising two general vertically arranged levers 510, 512 connected to a respective gripper arm 504, 506. The levers 510, 512 are held within a channel 514 defined by the body section 502 and are configured to be pushed towards each other to move the gripper arms 504, 506 into the stowed position and to be pushed away from each other, against the walls of the channel 514, to move the gripper arms 504, 506 into the deployed position for engaging with a container 9. The gripper assembly 500 further comprises a biasing means, depicted here as a spring element 516, providing a biasing force to urge the levers 510, 512 in position against the walls of the channel 514, so as to hold the gripper arms 504, 506 in the deployed position in the event of a failure to the actuator.

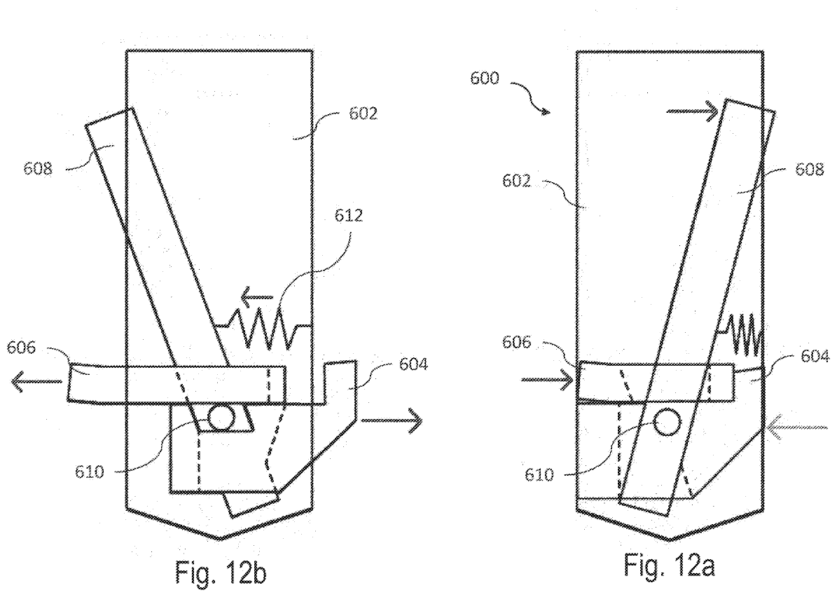

FIGS. 12a and 12b show a sixth embodiment of a gripper assembly 600 comprising a body section 602 carrying two gripper arms 604, 606 moveable generally horizontally between a stowed position in which the gripper arms 604, 606 are held within a cavity of the body section 602, as shown in FIG. 12a, and a deployed position in which the gripper arms 604, 606 outwardly extend from the body section 602 to engage a container 9, as shown in FIG. 12b. The gripper assembly 600 further comprises an actuator comprising a lever 608 pivotable about a pin 610 in a first direction to move the gripper arms 604, 606 into the stowed position and a second opposed direction to move the gripper arms 604, 606 into the deployed position. One of the gripper arms 604 is connected to the lever 608 below the pivot point, defined by the pin 610, and the other gripper arm 606 is connected to the lever 608 above the pivot, such that, when a force is applied to the lever 608, the gripper arms 604, 606 move in opposite directions between the stowed and deployed positions. The gripper assembly 600 further comprises a biasing means, depicted here as a spring element 612, providing a biasing force to urge the gripper arms 604, 606 in the deployed position in the event of a failure to the actuator.

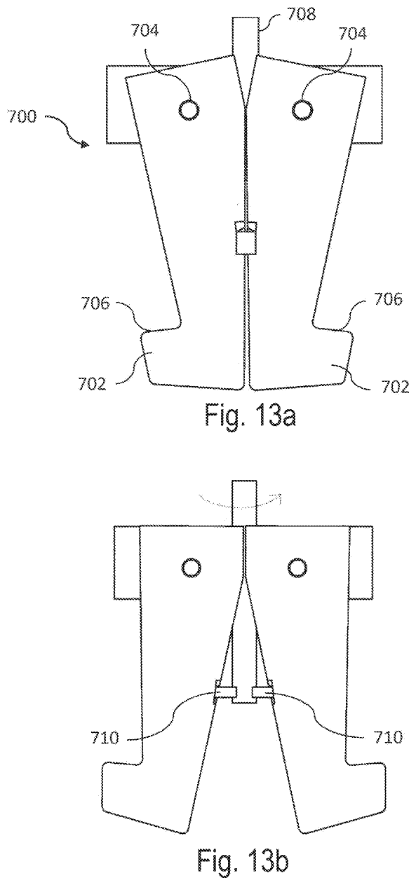

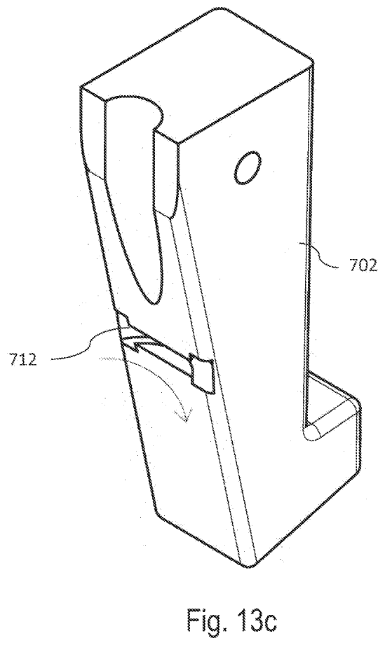

FIGS. 13a to 13c show a seventh embodiment of a gripper assembly 700 for use on the load-handling devices 31 described herein. The gripper assembly 700 comprises a pair of gripper arms 702 moveable, about respective pins 704 each defining a rotational axis, between a closed configuration, as shown in the FIG. 13a, and an open configuration, as shown in FIG. 13b. The gripper arms 702 each comprise a hooked end 706, defining an upper surface with which to engage an underside of a container rim during the lifting of the container 9. The gripper assembly 700 further comprises an actuator having a rotatable shaft 708 extending downwardly between the gripper arms 702. The shaft 708 comprises at its lower end two diametrically opposed lateral bars 710 and is rotatable to a first position in which the lateral bars 710 are orientated orthogonally with respect to the gripper arms 702. That is to say, when the shaft 708 is in the first position, the lateral bars 710 extend in the same direction as the rotational axes defined by the pins 704, preventing any interaction with the gripper arms 702 and allowing them to move to the closed configuration as shown in FIG. 13a. From here, the actuator is configured to rotate the shaft 708 to a second position, during which movement the distal ends of the lateral bars 710 enter into respective arcuate tracks 712 formed within the gripper arms 702 (see FIG. 13c). The tracks 712 are configured to guide movement of the lateral bars 710 when the shaft 708 is rotated to or from the second position, in which the lateral bars 710 extend between the gripper arms 702, holding them in the open configuration as shown in FIG. 13b. The gripper assembly 700 further comprises a biasing means configured to provide a force to bias the shaft 708 in the second position, ensuring that the gripper arms 702 remain in the open configuration in the event of a failure to the actuator.

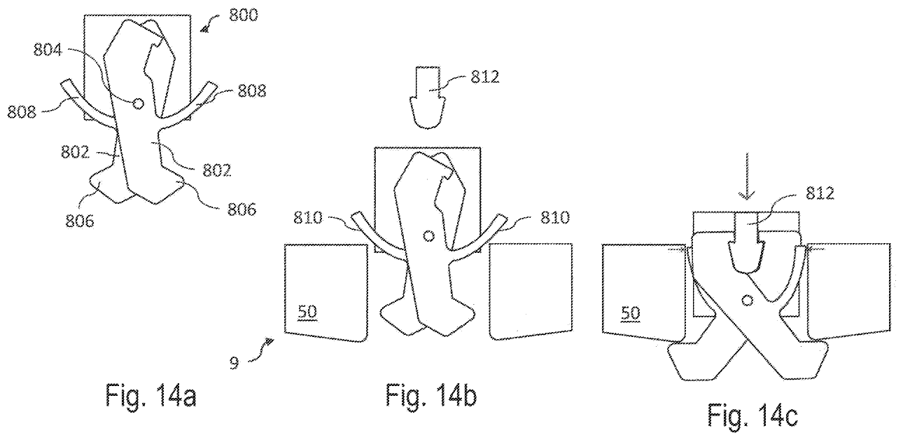

FIGS. 14a to 14c show an eighth embodiment of a gripper assembly 800 comprises a pair of gripper arms 802 moveable, about a pin 804 defining a rotational axis, between a closed configuration, as shown in the FIGS. 14a and 14b, and an open configuration, as shown in FIG. 14c. The gripper arms 802 each comprise a hooked end 806, defining an upper surface with which to engage an underside of the container rim 50 during the lifting of the container 9 when the gripper arms 802 are in the open configuration. Each of the gripper arms 802 further comprise an arcuate arm 808 extending laterally from an outer side of the gripper arm 802 and curving upwards, the outer side defining a leading edge of the gripper arm 802, as opposed to a trailing edge, as the gripper arm 802 rotates from the closed to the open configuration. The gripper arms 802 are naturally biased into the closed configuration and are actuated passively as gripper assembly 800 passes through a recess or opening in the container rim 50 as the gripper plate 49 is lowered. To that end, the underside of each of the arcuate arms 808 define a contacting surface 810 that engages with the container surfaces defined by the opening in the container rim 50 to convert the linear vertical motion of the gripper assembly 800 as it is lowered through the opening to a rotational motion of the gripper arms 802, moving the gripper arms 802 to the open configuration as shown in FIG. 14c. The gripper assembly 800 may further comprise an actuator comprising a plunger 812 configured to interact with cooperating surfaces on the upper ends of the gripper arms 802. Once the gripper assembly 800 is in the open configuration, the plunger 812 is actuated downwards into a position between the gripper arms 802, locking the gripper assembly 800 in the open configuration. The gripper assembly 800 can only then return to the closed configuration once the plunger is removed and the gripper assembly 800 is lifted from the opening in the container rim 50.

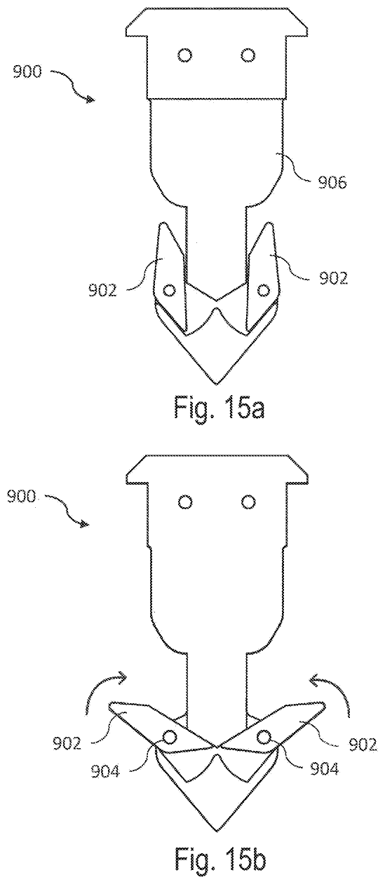

FIGS. 15a to 15c show a ninth embodiment of a gripper assembly 900 for latching onto a storage container 9 comprising a pair of gripper arms 902 moveable, about respective pins 904 each defining a rotational axis, between a stowed configuration, as shown in FIG. 15a, and a deployed configuration for engaging with the storage container 9, as shown in FIG. 15b. With reference to FIG. 15c, the gripper assembly 900 comprises a body section 906 defining a number of internal channels, together with a biasing means, which in this embodiment comprises a torsion springs 908, providing a force to bias the pair of gripper arms 902 in the deployed configuration. One end of each torsion spring 908 is housed within a respective channel defined within the body section 906 and the other end extends outwardly therefrom and is connected to respective gripper arms 902, being arranged to urge the gripper arms 902 away from the stowed configuration into the deployed configuration. The gripper assembly 900 further comprises an actuator comprising two wires or cables 910 extending through a third channel defined within the body section 906 and connecting to a respective gripper arm 902. The actuator is configured to pull the two wires 910 to move the gripper arms 902 to the stowed configuration and enable them to return to the deployed configuration under the restoring force of the torsion springs 908.

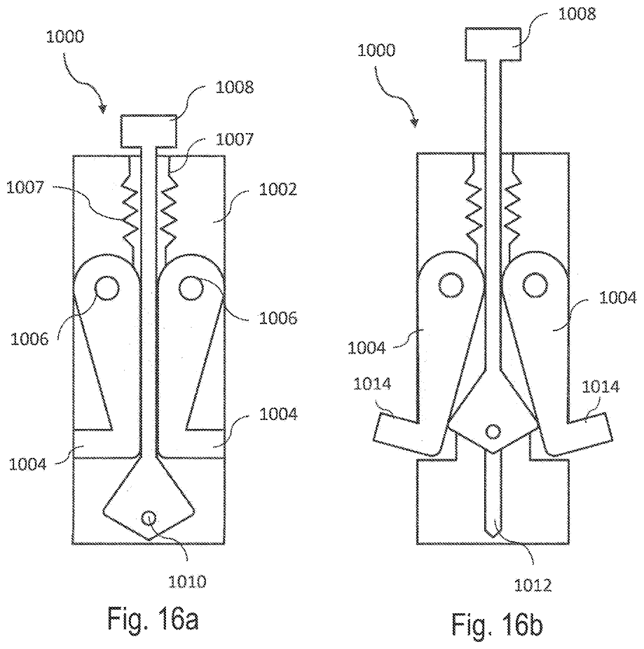

FIGS. 16a and 16b show a tenth embodiment of a gripper assembly 1000 for use on the load-handling devices 31 described herein. Again, the gripper assembly 1000 comprises a body section 1002, a pair of gripper arms 1004 moveable, about respective pins 1006 each of which define a rotational axis, between a stowed configuration, as shown in the FIG. 16a, and a deployed configuration, as shown in FIG. 16b. The gripper arms 1004 are urged into the stowed position by springs 1007. The gripper assembly 1000 further comprises an actuator comprising a plunger 1008 having a somewhat like diamond shape at its lower end, which carries a guide pin 1010. The guide pin 1010 runs within a track 1012 formed in the body section 1002 to guide the vertical movement of the plunger 1008 as the gripper assembly 1000 is actuated. When in the stowed position, the plunger 1008 extends downwards between the gripper arms 1004 and the diamond shaped lower end of the plunger 1008 is held below the gripper arms 1004. From this position, the plunger 1008 is moved upwards in order to move the gripper arms 1004 into the deployed position. During this upward movement, the upper surfaces of the diamond shaped lower end of the plunger 1008, which define a contact faces, are configured to exert a force on the gripper arms 1004, causing them to prise open and rotate about their respective pins 1006 to the deployed position, where hooked ends 1014 are arranged to engage an underside of the container 9 during the lifting of the container 9.

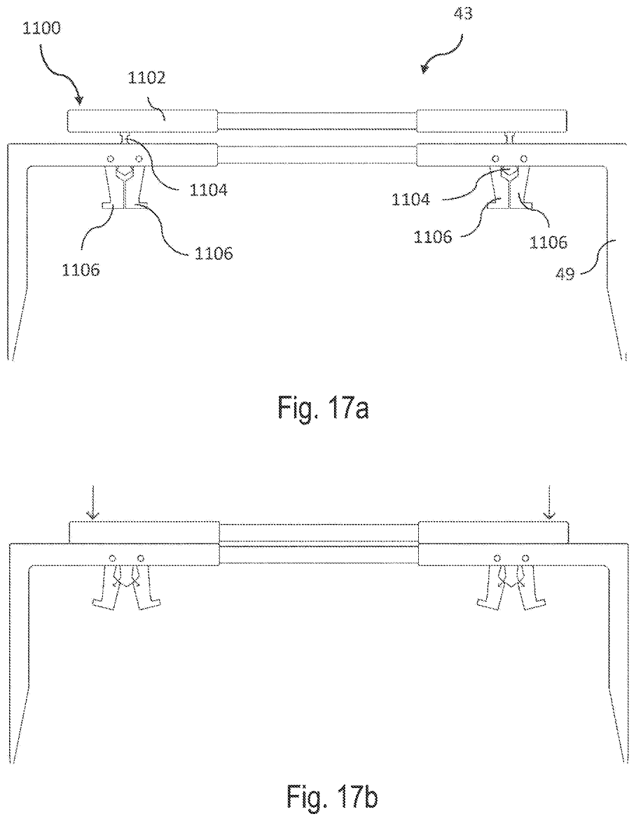

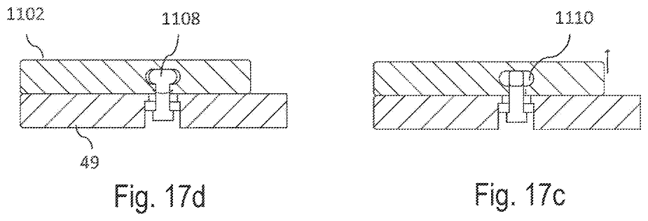

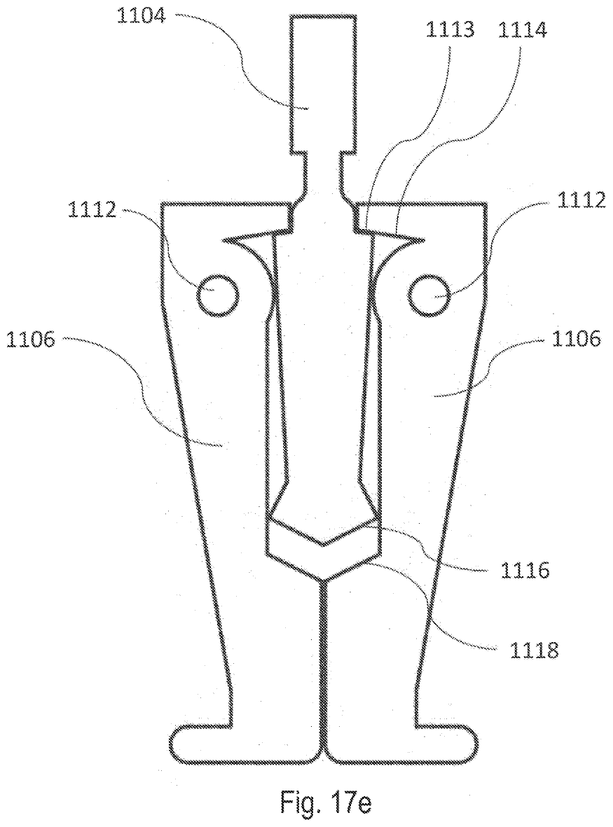

FIGS. 17a to 17e show an eleventh embodiment of a gripper assembly 1100 for latching onto a storage container 9. With reference to FIGS. 17a and 17b, showing the container-engaging assembly 43 comprising the gripper plate 49 and the gripper assembly 1100, the gripper assembly 1100 is actuated passively by the relative vertical movement between the gripper plate 49 and a plate 1102 of the gripper assembly 1100 during the lowering and raising of the container-engaging assembly 43. The plate 1102 is positioned above the gripper plate 49 and is directly connected to the tapes 41 of the container-lifting means 39. As the container-engaging assembly 43 is lowered by the container-lifting means 39 and the gripper plate 49 contacts or engages with the container 9, preventing it from being lowered further as shown in FIG. 17a, the plate 1102 of the gripper assembly 1100 continues to descend relative to the gripper plate 49 until it contacts the gripper plate 49, as shown in FIG. 17b. This relative downwards movement between the plates 49, 1102 forces plungers 1104 downwards, which in turn causes gripper arms 1106 to move from a closed configuration, as shown in FIG. 17a, to an open configuration for engaging the container 9, as shown in FIG. 17b. This gripper assembly 1100 further comprises a locking mechanism for locking together the plates 49, 1102, preventing relative movement therebetween and thus holding the gripper arms 1106 in the open configuration, so that the container 9 can be retrieved from its stack. In this embodiment, the locking mechanism comprises a ring lock 1108, as shown in FIGS. 17c and 17d. The ring lock 1108 is aligned so as to be received within a cavity 1110 of the plate 1102 of the gripper assembly 1100 as the plates 49, 1102 are brought together when in an unlocked position, as shown in FIG. 17c, and is actuated to a locked position, as shown in FIG. 17d, to lock the plates 49, 1102 together. In order to disengage the container 9, the ring lock 1108 is moved to the unlocked position and the container-engaging assembly 43 is lifted upwards by the container-lifting means 39, initially causing the plate 1102 of the gripper assembly 1100 to move upwards relative to the gripper plate 49. This relative movement lifts the plungers 1104 upwards causing the gripper arms 1106 to move back to the closed configuration. Turning to FIG. 17e, which shows the plunger 1104 in its uppermost position, the gripper arms 1106 are pivotable between the closed and open configurations about pivots 1112. During this movement, the plunger 1104 moves from having faces 1113 and 1114 in contact with each other to faces 1116, 1118 contacting each other. When the plunger 1104 contacts faces 1116, 1118, it pushes the gripper arms 1106 outwards until the plate 1102 of the gripper assembly 1100 comes to a rest on the gripper plate 49. To close the gripper arms 1106 again after the ring lock 1108 is disengaged, the top plate 1102 need only move upwards in its normal action. This will pull the plunger 1104 upwards, bringing into contact the faces 1113, 1114 and causing the gripper arms 1106 to rotate about pivots 1112 into the closed configuration.

It will be appreciated by those skilled in the art that the present invention has been described by way of example only, and that a variety of alternative approaches may be adopted without departing from the scope of the invention as defined by the appended claims.

1. A load-handling device for lifting and moving storage containers stacked in a grid framework structure, the grid framework structure including a first set of parallel rails or tracks and a second set of parallel rails or tracks extending substantially perpendicularly to the first set of rails or tracks, in a substantially horizontal plane to form a grid pattern having a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising:
a body mounted on a first set of wheels configured and arranged to engage with the first set of parallel rails or tracks and a second set of wheels configured and arranged to engage with the second set of parallel rails or tracks; and
a gripper assembly configured for latching onto a storage container, the gripper assembly including:
a pair of gripper arms moveable between an open configuration, in which the pair of gripper arms are configured to engage with a storage container, and a closed configuration, in which the pair of gripper arms are prevented from engaging a storage container, wherein each gripper arm of the pair of gripper arms includes a track; and
an actuator including a plunger and two pins connected to the plunger, each pin being moveably received within a respective gripper arm track of the pair of gripper arms, wherein the plunger is configured to move in an opening stroke to move the pair of gripper arms into the open configuration and a closing stroke to move the pair of gripper arms into the closed configuration, and wherein the tracks are arranged to diverge with respect to each other in a direction of the closing stroke when the pair of gripper arms are in the closed configuration.

2. A load-handling device according to claim 1, wherein each gripper arm of the pair of gripper arms is configured to be movable about a respective rotational axis.

3. A load-handling device according to claim 2, wherein the gripper arm tracks are located between the rotational axis and an end of their respective gripper arm connected to the plunger.

4. A load-handling device according to claim 2, in combination with a grid framework structure having storage containers, wherein the gripper arm tracks are located between the rotational axis and an end of their respective gripper arm configured to engage a storage container.

5. A load-handling device according to claim 2, wherein the gripper arm tracks are offset from and extend along either side of the rotational axis of their respective gripper arm.

6. A load-handling device according to claim 1, wherein the gripper arm track of each gripper arm comprises:
a slot, and wherein the two pins extend through their respective slot and are connected to the plunger at each of their ends.

7. A load-handling device according to claim 1, wherein the gripper assembly comprises:
a brace connecting the plunger and pins.

8. A load-handling device according to claim 7, wherein the brace is configured to substantially prevent relative spatial movement between the pins.

9. A load-handling device according to claim 8, wherein the brace and pins are configured to allow each pin to rotate about its longitudinal axis.

10. A load-handling device according to claim 1, wherein the gripper assembly comprises:
a housing configured to limit movement of the gripper assembly with respect to a storage container.

11. A load-handling device according to claim 10, wherein the pins and gripper arm tracks are located within the housing.

12. A load-handling device according to claim 2, wherein the gripper assembly comprises:
a biasing means for biasing the gripper arms in the open configuration.

13. A load-handling device according to claim 12, wherein the rotational axis of each gripper arm is positioned towards an outer side of the gripper arm.

14. A load-handling device for lifting and moving storage containers stacked in a grid framework structure the grid framework structure including a first set of parallel rails or tracks and a second set of parallel rails or tracks extending substantially perpendicularly to the first set of rails or tracks in a substantially horizontal plane to form a grid pattern having a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising:
a body mounted on a first set of wheels being arranged to engage with the first set of parallel rails or tracks and a second set of wheels being configured and arranged to engage with the second set of parallel rails or tracks; and
a gripper assembly configured for latching onto a storage container, the gripper assembly including:
a body section;
a single gripper arm configured to move between a stowed position, in which the arm is received within the body section, and a deployed position for engaging with a storage container; and
an actuator including a pin connected to the arm, wherein the pin is configured to move between first and second positions to move the arm between the stowed and deployed positions respectively.

15. A load-handling device according to claim 14, wherein the pin is configured to rotate about its longitudinal axis to move between the first and second positions.

16. A load-handling device according to claim 15, wherein the body section comprises:
a collar configured to limit movement of the gripper assembly with respect to a storage container.

17. A load-handling device according to claim 16, wherein an end of the body section remote from the actuator is tapered.

18. A load-handling device according to claim 17, wherein the gripper assembly comprises:
a biasing means for biasing the arm in the deployed position.

19. A load-handling device according to claim 18, wherein the pin extends into the body section on either side of the gripper arm.

20. A load-handling device according to claim 19, wherein the gripper arm comprises:
convex surfaces, each having an apex configured to slidably engage with the body section.

21. A load-handling device for lifting and moving storage containers stacked in a grid framework structure, the grid framework structure including a first set of parallel rails or tracks, and a second set of parallel rails or tracks extending substantially perpendicularly to the first set of rails or tracks in a substantially horizontal plane to form a grid pattern having a plurality of grid spaces, wherein the grid is supported by a set of uprights to form a plurality of vertical storage locations beneath the grid for storage containers to be stacked between and be guided by the uprights in a vertical direction through the plurality of grid spaces, the load-handling device comprising:
a body mounted on a first set of wheels configured and arranged to engage with the first set of parallel rails or tracks and a second set of wheels configured and arranged to engage with the second set of parallel rails or tracks; and
a gripper assembly for latching onto a storage container, the gripper assembly including:
a pair of gripper arms moveable between a stowed configuration and a deployed configuration for engaging with a storage container;
biasing means for providing a force to bias the pair of gripper arms in the deployed configuration; and
an actuator including two wires, each wire being connected to a respective gripper arm of the pair of gripper arms, wherein the actuator is configured to pull the two wires to move the pair of gripper arms to the stowed configuration and enable the gripper arms to return to the deployed configuration under the force of the biasing means.

22. A load-handling device according to claim 21, wherein the actuator is configured to wind the two wires in order to move the pair of gripper arms and unwind the two wires to enable the gripper arms to return to the deployed configuration under the force of the biasing means.

23. A load-handling device according to claim 22, wherein the gripper assembly comprises;
a body section, and wherein the two wires extend between the actuator and their respective gripper arm through the body section.

24. A load-handling device according to claim 23, wherein an end of the body section remote from the actuator is tapered.
